(19) United States
(12) Patent Application Publication
(10) Pub. No.: US 2024/0085313 A1
(43) Pub. Date: Mar. 14, 2024

(54) CONCENTRATION MEASURING DEVICE

(71) Applicant: ATIK Co., Ltd., Seoul (KR)

(72) Inventors: Youngho HONG, Seoul (KR); Kyungwon PARK, Gyeonggi-do (KR); Dongchul LEE, Seoul (KR); Yongjin LEE, Gyeonggi-do (KR); Rakhyeun JO, Gyeonggi-do (KR)

(21) Appl. No.: 18/210,154

(22) Filed: Jun. 15, 2023

(30) Foreign Application Priority Data
Jun. 16, 2022 (KR) 10-2022-0073401

(51) Int. Cl. G01N 21/31

(52) U.S. Cl. CPC G01N 21/31; G01N 2201/0231; G01N 2201/0636

(57) ABSTRACT

A concentration measuring device according to an embodiment may include a light-emitting unit configured to generate measurement light, a measurement unit configured to receive first measurement light that is part of the measurement light and that passes through a sample that is a measurement target, and a reference measurement unit configured to receive second measurement light that is part of the measurement light and that does not pass through the sample, wherein the concentration measuring device may be configured to measure a concentration of a chemical material in the sample by measuring an amount of light absorbed by the sample based on an amount of light detected by the measurement unit and an amount of light detected by the reference measurement unit.

### CROSS-REFERENCE TO RELATED APPLICATION

This application claims the benefit of Korean Patent Application No. 10-2022-0073401 filed on Jun. 16, 2022, in the Korean Intellectual Property Office, the entire disclosure of which is incorporated herein by reference for all purposes.

### BACKGROUND

### 1. Field of the Invention

The following embodiments relate to a concentration measuring device.

### 2. Description of the Related Art

Semiconductors are manufactured through several steps, and in an etching processing step, for example, a chemical solution may be used. Since the concentration of the chemical solution may affect the quality of a semiconductor, the concentration of the chemical solution used in manufacturing the semiconductor needs to be kept constant.

In order to manage the concentration of the chemical solution, the concentration of the chemical solution may be measured. For example, the concentration of the chemical solution may be measured using a titration method or by determining the degree of light absorption. For example, Korean Patent Publication No. 10-2021-0048111 discloses a concentration measuring device, the system thereof, and a concentration measuring method.

The above description is information the inventor(s) acquired during the course of conceiving the present disclosure, or already possessed at the time, and is not necessarily art publicly known before the present application was filed.

### SUMMARY

An aspect according to an embodiment is to provide a concentration measuring device that may measure a concentration of a chemical solution.

An aspect according to an embodiment is to provide a concentration measuring device that may obtain a reliable measurement result by maintaining a suitable temperature for measurement.

An aspect according to an embodiment is to provide a concentration measuring device that may monitor the degree of aging of parts of the concentration measuring device.

An aspect according to an embodiment is to provide a concentration measuring device that may determine whether there is an abnormality by performing self-verification.

A concentration measuring device according to an embodiment includes a light-emitting unit including a first light source configured to generate measurement light, a measurement unit configured to receive first measurement light that is part of the measurement light and that passes through a sample that is a measurement target, and a reference measurement unit configured to receive second measurement light that is part of the measurement light and that does not pass through the sample. The concentration measuring device is configured to measure a concentration of a chemical material in the sample by measuring an amount of light absorbed by the sample based on an amount of light detected by the measurement unit and an amount of light detected by the reference measurement unit.

The measurement unit may include a measurement photodiode sensor configured to receive the first measurement light and a first lens configured to focus the first measurement light on the measurement photodiode sensor.

The reference measurement unit may include a reference photodiode sensor configured to receive the second measurement light and a second lens configured to focus the second measurement light on the reference photodiode sensor. The concentration measuring device may further include a spectroscopic unit disposed between the light-emitting unit and the sample and configured to separate the measurement light into the first measurement light and the second measurement light, wherein the spectroscopic unit may be a beam splitter configured to transmit the first measurement light and reflect the second measurement light.

The concentration measuring device according to an embodiment may further include a housing in which the light-emitting unit, the measurement unit, and the reference measurement unit are disposed and a constant temperature module disposed inside the housing and configured to maintain a temperature inside the housing, wherein the constant temperature module may include a sample supply tube extending across at least part of the housing, a heat sink connected to the first light source and configured to dissipate heat of the first light source, a temperature detection sensor configured to detect the temperature inside the housing, and a fan configured to cool an inside of the housing.

The concentration measuring device according to an embodiment may further include a reflection mirror disposed between the beam splitter and the reference measurement unit and configured to direct the second measurement light to the reference measurement unit.

A concentration measuring device according to an embodiment may include a light-emitting unit including a first light source configured to generate measurement light, a measurement unit configured to receive the measurement light that passes through a sample that is a measurement target of the measurement light, and a verification unit configured to verify an abnormal state of the measurement unit, wherein the verification unit may include a second light source configured to generate verification light and the verification light may be configured to be received by the measurement unit without passing through the sample.

The verification unit may further include an optical filter configured to filter light of a specific wavelength, the optical filter may be disposed between the measurement unit and the sample and configured to transmit the measurement light and reflect the verification light toward the measurement unit, and the abnormal state of the measurement unit may be verified by comparing an amount of the verification light generated by the second light source to an amount of the verification light received by the measurement unit.

A concentration measuring device according to an embodiment may include a light-emitting unit including a first light source configured to generate measurement light, a verification unit including a second light source configured to generate verification light, a spectroscopic unit configured to separate the measurement light into first measurement light and second measurement light, the spectroscopic unit being disposed between the light-emitting unit and a sample that is a measurement target, a measurement unit configured to receive the first measurement light that passes through the sample, and a reference measurement unit configured to receive the second measurement light that does not pass through the sample. The concentration measuring device may be configured to measure a concentration of a chemical material in the sample by measuring an amount of light absorbed by the sample based on an amount of light detected by the measurement unit and an amount of light detected by the reference measurement unit. An abnormal state of the measurement unit may be verified by the verification light, the measurement unit may include a measurement photodiode sensor, the reference measurement unit may include a reference photodiode sensor, and the spectroscopic unit may be a beam splitter configured to transmit the first measurement light and reflect the second measurement light. A replacement notification of the concentration measuring device may be provided according to a degree of aging of the measurement photodiode sensor or the reference photodiode sensor.

A concentration measuring device according to an embodiment may measure a concentration of a chemical solution.

The concentration measuring device according to an embodiment may obtain a reliable measurement result by maintaining a suitable temperature for measurement.

The concentration measuring device according to an embodiment may monitor the degree of aging of parts of the concentration measuring device.

The concentration measuring device according to an embodiment may determine whether there is an abnormality by performing self-verification.

The effects of the concentration measuring device according to embodiments are not limited to the above-mentioned effects, and other unmentioned effects can be clearly understood from the description below by one of ordinary skill in the art to which the present disclosure pertains.

### BRIEF DESCRIPTION OF THE DRAWINGS

FIG. 1 is a perspective view of an external shape of a concentration measuring device according to an embodiment;

FIG. 2 is a diagram schematically illustrating a concentration measuring device according to an embodiment;

FIG. 3 illustrates the principle of concentration measuring by a concentration measuring device according to an embodiment;

FIG. 4 illustrates a measurement mode of a concentration measuring device according to an embodiment;

FIG. 5 illustrates a transmittance of each wavelength of light for a hydrogen peroxide solution;

FIG. 6 illustrates a transmittance of each wavelength of light for sulfuric acid;

FIG. 7 illustrates a verification mode of a concentration measuring device according to an embodiment; and

FIG. 8 illustrates information related to aging measurement of a concentration measuring device according to an embodiment.

### DETAILED DESCRIPTION

Hereinafter, embodiments are described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. It should be noted that if one component is described as being “connected”, “coupled” or “joined” to another component, the former may be directly “connected,” “coupled”, and “joined” to the latter or “connected”, “coupled”, and “joined” to the latter via another component.

A component, which has the same common function as a component included in any one embodiment, will be described by using the same name in other embodiments. Unless disclosed to the contrary, the configuration disclosed in any one embodiment may be applied to other embodiments, and the specific description of the repeated configuration will be omitted.

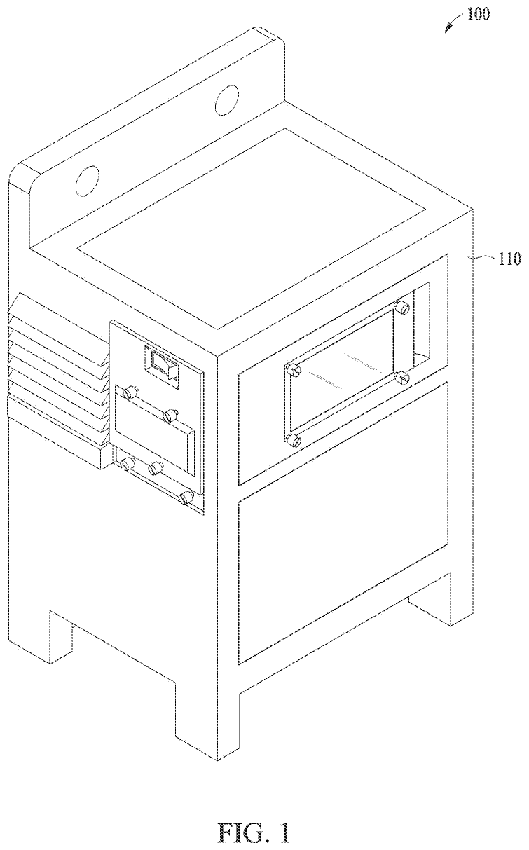

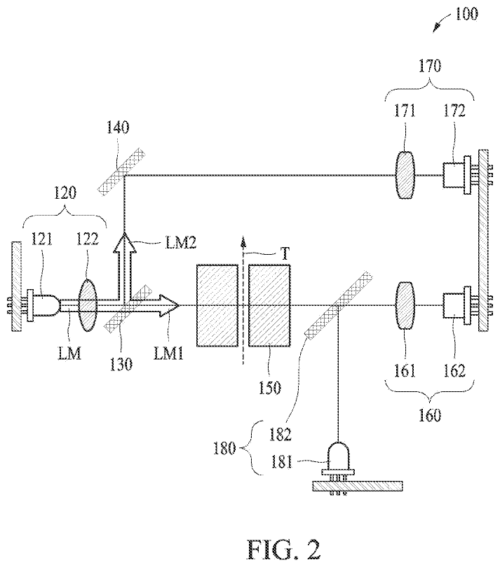

FIG. 1 is a perspective view of an external shape of a concentration measuring device 100 according to an embodiment, and FIG. 2 is a diagram schematically illustrating the concentration measuring device 100 according to an embodiment.

The concentration measuring device 100 according to an embodiment may include components as shown in FIG. 2, and the components shown in FIG. 2 may be accommodated in an arbitrary position inside a housing 110 that has a shape shown in FIG. 1.

Referring to FIG. 1, the shape of the housing 110 that may form the external shape of the concentration measuring device 100 according to an embodiment may vary.

Referring to FIG. 2, the concentration measuring device 100 according to an embodiment may include a light-emitting unit 120 configured to generate measurement light LM, a spectroscopic unit 130 configured to separate the measurement light LM into first measurement light LM1 and second measurement light LM2, which are part of the measurement light LM, a measurement unit 160 configured to receive the first measurement light LM1 that passes through a sample T that is a measurement target, a reference measurement unit 170 configured to receive the second measurement light LM2 that does not pass through the sample T, a reflection mirror 140 configured to direct the second measurement light LM2 to the reference measurement unit 170, a verification unit 180 configured to verify an abnormal state of the measurement unit 160, and a controller (not shown) configured to control the concentration measuring device 100.

The light-emitting unit 120 may include a first light source 121 configured to generate the measurement light LM and a collimating lens 122 capable of transmitting the measurement light LM in parallel. In addition, the first light source 121 may include a light-emitting diode (LED).

The wavelength of light generated by the first light source 121 may vary. This is described below.

For example, the spectroscopic unit 130 may be disposed between the light-emitting unit 120 and the sample T, and the spectroscopic unit 130 may transmit the first measurement light LM1 and reflect the second measurement light LM2. Furthermore, one of ordinary skill in the art may understand that distinction between the first measurement light LM1 and the second measurement light LM2 is a relative concept according to transmission and reflection.

In addition, the spectroscopic unit 130 may be a beam splitter configured to transmit the first measurement light LM1 and reflect the second measurement light LM2. The beam splitter may have various orientations toward the measurement light LM. For example, the beam splitter may be oriented to transmit the first measurement light LM1 that is part of the measurement light LM and reflect the second measurement light LM2 that is part of the measurement light LM. For example, the beam splitter may be oriented so that the incident measurement light LM may not be totally reflected.

In addition, the sample T that is a measurement target may be disposed in a sample unit 150. The sample T may be supplied to the sample unit 150 through a pipe (not shown) installed from the outside.

The measurement unit 160 may include a measurement photodiode sensor 162 configured to receive the first measurement light LM1 and a first lens 161 configured to focus the first measurement light LM1 on the measurement photodiode sensor 162.

The measurement photodiode sensor 162 may be a photodiode sensor capable of converting an optical signal into an electrical signal. For example, the measurement photodiode sensor 162 may convert the amount of light of the received first measurement light LM1 into an electrical signal and transmit the electrical signal to the controller (not shown).

The first lens 161 may focus the first measurement light LM1 on the measurement photodiode sensor 162 so that the first measurement light LM1 may be received by the measurement photodiode sensor 162. The first lens 161 may be various types of lenses. The first lens 161 may be, for example, a spherical lens or an aspherical lens.

The reflection mirror 140 may be disposed between the beam splitter and the reference measurement unit 170. The reflection mirror 140 may be various types of mirrors. For example, the reflection mirror 140 may be a flat mirror that may reflect the entire incident second measurement light LM2 in parallel.

The reference measurement unit 170 may include a reference photodiode sensor 172 configured to receive the second measurement light LM2 and a second lens 171 configured to focus the second measurement light LM2 on the reference photodiode sensor 172.

The reference photodiode sensor 172 may be a photodiode sensor capable of converting an optical signal into an electrical signal. For example, the reference photodiode sensor 172 may convert the amount of light of the received second measurement light LM2 into an electrical signal and transmit the electrical signal to the controller (not shown).

The second lens 171 may focus the second measurement light LM2 on the reference photodiode sensor 172 so that the second measurement light LM2 may be received by the reference photodiode sensor 172. The second lens 171 may be various types of lenses. The second lens 171 may be, for example, a spherical lens or an aspherical lens.

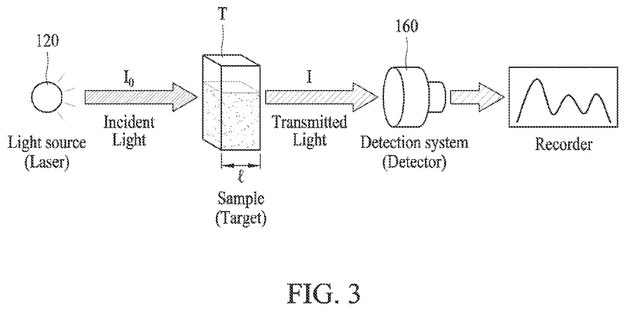

FIG. 3 illustrates the principle of concentration measuring by the concentration measuring device 100 according to an embodiment. Hereinafter, the principle of concentration measuring by the concentration measuring device 100 according to an embodiment is described.

Referring to FIG. 3, some components of the concentration measuring device 100 according to an embodiment are shown. After light is generated by a light source that may correspond to the light-emitting unit 120, the light may be transmitted to the sample T. The transmitted light may be received by a detector that may correspond to the measurement unit 160. Here, the degree of light absorption may vary according to the concentration of hydrogen peroxide (H₂O₂) or sulfuric acid (H₂SO₄) in the sample T. Accordingly, the concentration of chemical substance in the sample T may be measured by measuring the amount of light absorbed by the sample T based on the amount of light before the transmission of light and the amount of light after the transmission of light.

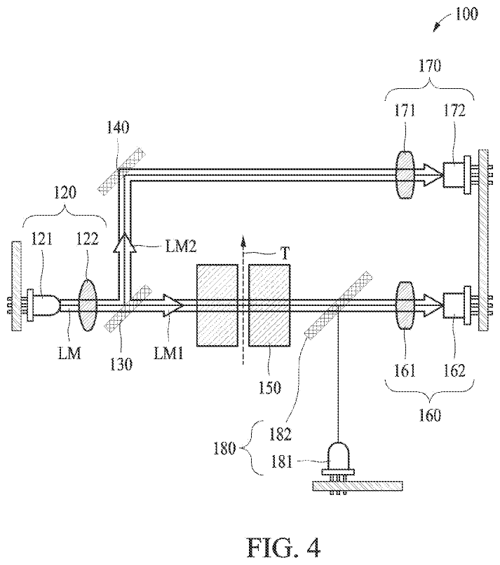

FIG. 4 illustrates a measurement mode of the concentration measuring device 100 according to an embodiment.

Referring to FIGS. 2 and 4 together, in the concentration measuring device 100 according to an embodiment, by the beam splitter configured to separate the measurement light LM into the first measurement light LM1 and the second measurement light LM2, the same measurement light LM may be separated into two partial lights having the same wavelength and received by the measurement unit 160 and the reference measurement unit 170, respectively.

The first measurement light LM1 passes through the sample T and may thus be partially absorbed, but the second measurement light LM2 does not pass through the sample T and may thus not be absorbed at all. Since the amount of light after light absorption may be known through the first measurement light LM1 and the amount of light of the measurement light LM itself that is not absorbed may be known through the second measurement light LM2, the amount of light absorption may be measured by comparing the first measurement light LM1 to the second measurement light LM2. In conclusion, the concentration measuring device 100 may measure the concentration of the chemical substance in the sample T through the amount of light absorption.

Here, since a specific solution may absorb a large amount of light of a specific wavelength depending on the type of solution, light of an appropriate wavelength may be selected depending on the type of solution of the sample T that is the measurement target. Light of an appropriate wavelength for the hydrogen peroxide solution and the sulfuric acid solution is described below.

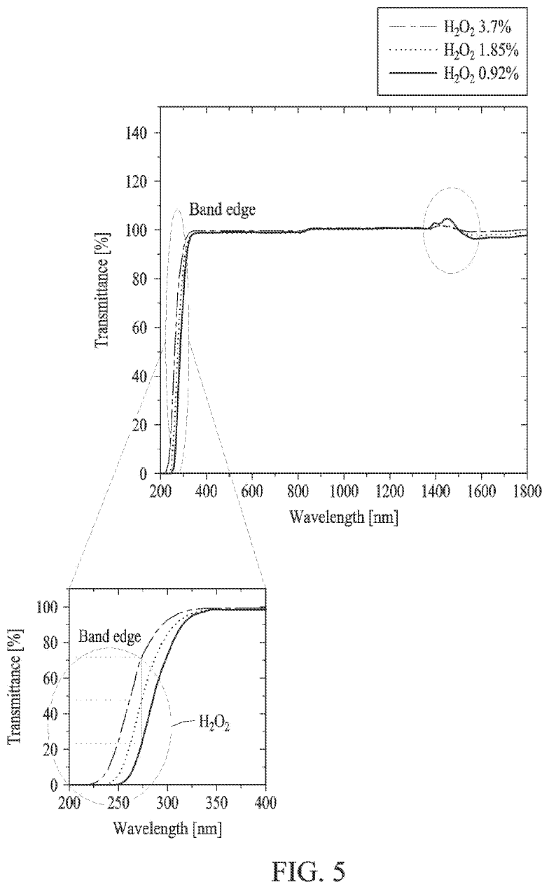

FIG. 5 illustrates a transmittance of each wavelength of light for a hydrogen peroxide solution.

Referring to FIG. 5, an x-axis represents a wavelength and a y-axis represents a transmittance. If the transmittance is high at a specific wavelength, it means that light absorption for the solution does not occur easily at the specific wavelength.

It may be found that the degree of transmittance of light greatly varies depending on a difference in concentration (e.g., 3.7%, 1.85%, and 0.92%) of the hydrogen peroxide solution in the ultraviolet region of about 275 nanometers (nm). Therefore, when the concentration of hydrogen peroxide in the solution is measured, measurement light (e.g., the measurement light LM of FIG. 4) in the ultraviolet region may be used.

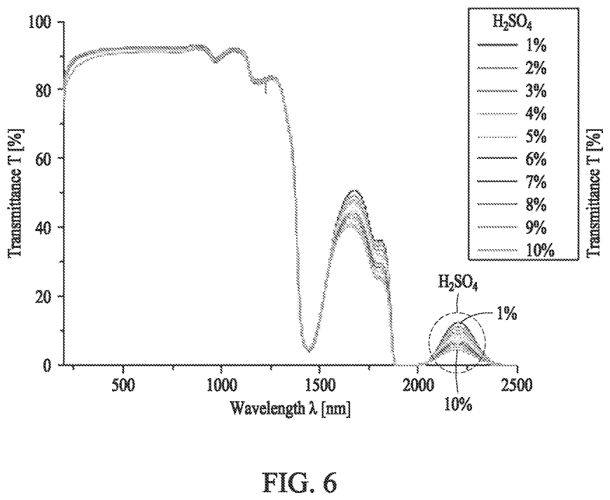

FIG. 6 illustrates a transmittance of each wavelength of light for sulfuric acid;

Referring to FIG. 6, an x-axis represents a wavelength and a y-axis represents a transmittance. If the transmittance is high at a specific wavelength, it means that light absorption for the solution does not occur easily at the specific wavelength.

It may be found that the degree of transmittance of light greatly varies depending on a difference in concentration (e.g., 1 to 10%) of sulfuric acid in the infrared range of about 2200 nm. Therefore, when the concentration of sulfuric acid in the solution is measured, measurement light (e.g., the measurement light LM in FIG. 4) in the infrared range may be used.

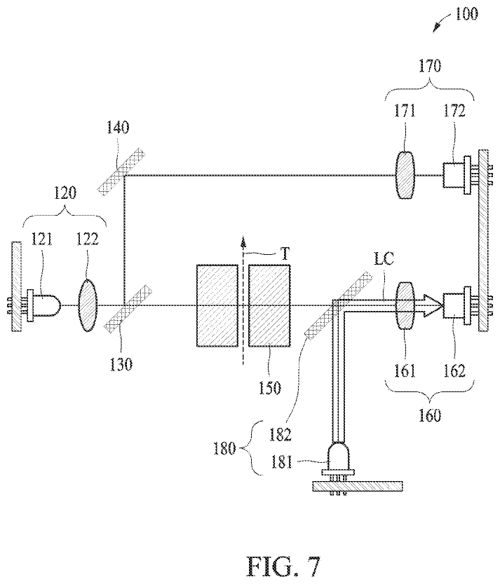

FIG. 7 illustrates a verification mode of the concentration measuring device 100 according to an embodiment.

Referring to FIG. 7, the verification unit 180 may include a second light source 181 configured to generate verification light LC and an optical filter 182 configured to filter light of a specific wavelength. The verification light LC may be received by the measurement photodiode sensor 162 of the measurement unit 160 without passing through the sample T.

The optical filter 182 may be disposed between the sample unit 150 and the measurement unit 160.

In addition, the optical filter 182 may transmit the measurement light LM so as not to have an influence on the measurement light LM in the measurement mode shown in FIG. 4 and may reflect the verification light LC toward the measurement unit 160 for the verification light LC to function only in the verification mode.

For example, the optical filter 182 may be a band-pass filter. For example, the optical filter 182 may be a band-pass filter that may transmit light in the infrared and ultraviolet regions, which may be used as measurement light (e.g., the measurement light LM in FIG. 4), and that may reflect light in the region between infrared rays and ultraviolet rays.

Accordingly, the verification light LC may be light in the region between the infrared rays and the ultraviolet rays. For example, the verification light LC may be light having a wavelength between 240 nm and 2200 nm. For example, the verification light LC may be light having a wavelength of about 515 nm.

In the verification mode, the measurement light LM may not be generated by the first light source 121 and only the verification light LC may be generated by the second light source 181. Subsequently, the verification light LC may be received by the measurement photodiode sensor 162 of the measurement unit 160 through the optical filter 182, and an abnormal state of the measurement unit 160 may be verified by comparing the amount of light of the verification light LC generated by the second light source 181 to the amount of light of the verification light LC received by the measurement unit 160. For example, when an error occurs in the measurement photodiode sensor 162, a value different from the amount of the generated verification light LC may be measured, and when an error does not occur in the measurement photodiode sensor 162, a value equal to the amount of the generated verification light LC may be measured.

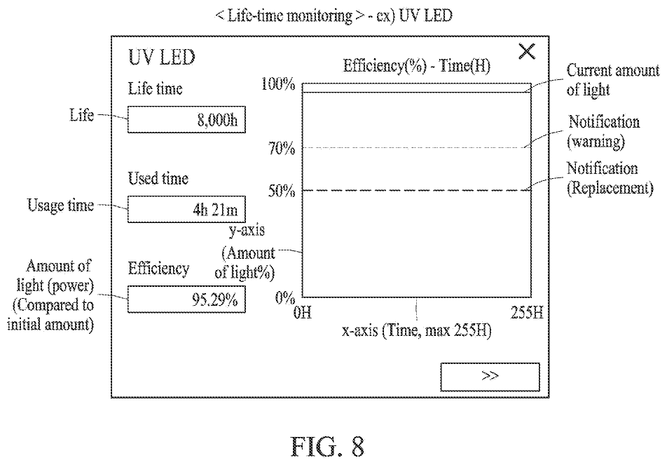

FIG. 8 illustrates information related to aging measurement of the concentration measuring device 100 according to an embodiment. For example, the concentration measuring device 100 may include a display (not shown) capable of displaying information, and information as shown in FIG. 8 may be displayed on the display.

In relation to the aging measurement, the life, usage time, amount of light measured by the reference measurement unit 170, and the like on the specifications of sensors may be displayed.

An alarm may be provided when the amount of light reduced by a predesignated ratio is measured compared to the amount of light initially measured by the reference measurement unit 170.

Since the concentration is measured by comparing the light (e.g., the second measurement light LM2 of FIG. 4) that does not pass through the sample T to the light (e.g., the first measurement light LM1 of FIG. 4) that passes through the sample T, a reliable value may be obtained regardless of the aging of the sensors.

In addition, the concentration measuring device 100 according to an embodiment may include a constant temperature module (not shown) disposed inside a housing. Since the amount of light absorption of a solution may vary depending on the temperature change, the constant temperature module may maintain the temperature for a suitable environment for measurement.

The constant temperature module may include a sample supply tube (not shown) extending across at least part of the housing (e.g., the housing 110 of FIG. 1), a heat sink (not shown) connected to a first light source (e.g., the first light source 121 of FIG. 2) and configured to dissipate heat of the first light source, a temperature detection sensor (not shown) configured to detect the temperature inside the housing, and a fan (not shown) configured to cool the inside of the housing.

The sample supply tube may be connected to, for example, a sample unit (e.g., the sample unit 150 of FIG. 2) to supply a sample to the sample unit. An extension path of the sample supply tube may vary. For example, the sample supply tube may partially extend straight, partially be curved, and partially be wound inside the housing. Since the sample supply tube may form a long sample supply path within the housing, the temperature of the sample may be maintained equal to or close to the temperature set in the housing.

The heat sink may dissipate heat that may be generated while the first light source generates measurement light.

The temperature detection sensor may detect the temperature inside the housing and provide temperature information for controlling the operation of the fan. For example, the temperature detection sensor may include a Peltier element, and when the temperature in the housing measured by the Peltier element is higher than a set temperature, the temperature in the housing may be maintained close to the set temperature by operating the fan.

While the embodiments are described with reference to a limited number of drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and/or equivalents of the claims are within the scope of the following claims.

What is claimed is:

1. A concentration measuring device comprising:
a light-emitting unit comprising a first light source configured to generate measurement light;
a measurement unit configured to receive first measurement light that is part of the measurement light and that passes through a sample that is a measurement target; and
a reference measurement unit configured to receive second measurement light that is part of the measurement light and that does not pass through the sample,
wherein the concentration measuring device is configured to measure a concentration of a chemical material in the sample by measuring an amount of light absorbed by the sample based on an amount of light detected by the measurement unit and an amount of light detected by the reference measurement unit.

2. The concentration measuring device of claim 1, wherein the measurement unit comprises:
a measurement photodiode sensor configured to receive the first measurement light; and
a first lens configured to focus the first measurement light on the measurement photodiode sensor.

3. The concentration measuring device of claim 2, wherein the reference measurement unit comprises:
a reference photodiode sensor configured to receive the second measurement light; and
a second lens configured to focus the second measurement light on the reference photodiode sensor.

4. The concentration measuring device of claim 1, further comprising a spectroscopic unit disposed between the light-emitting unit and the sample and configured to separate the measurement light into the first measurement light and the second measurement light,
wherein the spectroscopic unit is a beam splitter configured to transmit the first measurement light and reflect the second measurement light.

5. The concentration measuring device of claim 1, further comprising:
a housing in which the light-emitting unit, the measurement unit, and the reference measurement unit are disposed; and
a constant temperature module disposed inside the housing and configured to maintain a temperature inside the housing constant,
wherein the constant temperature module comprises:
a sample supply tube extending across at least part of the housing;
a heat sink connected to the first light source and configured to dissipate heat of the first light source;
a temperature detection sensor configured to detect the temperature inside the housing; and
a fan configured to cool an inside of the housing.

6. The concentration measuring device of claim 4, further comprising a reflection mirror disposed between the beam splitter and the reference measurement unit and configured to direct the second measurement light to the reference measurement unit.

7. A concentration measuring device comprising:
a light-emitting unit comprising a first light source configured to generate measurement light;
a measurement unit configured to receive the measurement light that passes through a sample that is a measurement target of the measurement light; and
a verification unit configured to verify an abnormal state of the measurement unit,
wherein the verification unit comprises a second light source configured to generate verification light and the verification light is configured to be received by the measurement unit without passing through the sample.

8. The concentration measuring device of claim 7, wherein
the verification unit further comprises an optical filter configured to filter light of a specific wavelength,
the optical filter is disposed between the measurement unit and the sample and configured to transmit the measurement light and reflect the verification light toward the measurement unit, and
the abnormal state of the measurement unit is verified by comparing an amount of the verification light generated by the second light source to an amount of the verification light received by the measurement unit.

9. A concentration measuring device comprising:
a light-emitting unit comprising a first light source configured to generate measurement light;
a verification unit comprising a second light source configured to generate verification light;
a spectroscopic unit configured to separate the measurement light into first measurement light and second measurement light, the spectroscopic unit being disposed between the light-emitting unit and a sample that is a measurement target;
a measurement unit configured to receive the first measurement light that passes through the sample; and
a reference measurement unit configured to receive the second measurement light that does not pass through the sample,
wherein the concentration measuring device is configured to measure a concentration of a chemical material in the sample by measuring an amount of light absorbed by the sample based on an amount of light detected by the measurement unit and an amount of light detected by the reference measurement unit,
wherein an abnormal state of the measurement unit is verified by the verification light,
wherein the measurement unit comprises a measurement photodiode sensor,
wherein the reference measurement unit comprises a reference photodiode sensor,
wherein the spectroscopic unit is a beam splitter configured to transmit the first measurement light and reflect the second measurement light, and
wherein a replacement notification of the concentration measuring device is provided according to a degree of aging of the measurement photodiode sensor or the reference photodiode sensor.
